(19) United States
(12) Patent Application Publication
(10) Pub. No.: US 2002/0083160 A1
(43) Pub. Date: Jun. 27, 2002

(54) Method and apparatus for managing applications and data in a mobile device

(76) Inventor: Don Middleton, Delta (CA)

Correspondence Address: BRIAN T. RIVERS, NOKIA INCORPORATED, 6000 CONNECTION DRIVE, MD 1-4-755, IRVING, TX, 75039, US

(21) Appl. No.: 09/746,354

(22) Filed: Dec. 21, 2000

(51) Int. Cl. G06F 15/177; G06F 15/16

(52) U.S. Cl. 709/221; 709/220; 709/203

(57) ABSTRACT

A method and apparatus for managing applications and data for mobile devices. In the method and apparatus, external memories of a mobile device and/or network storage may be used as secondary storage locations for relatively low use programs and data downloaded into a mobile device in a communications network. Both program and data may be stored in the secondary locations. According to the method and apparatus, the handling and management of storage in mobile device external memory and/or network storage and, the handling and management of the programs and data in the main memory device are performed in predetermined manner to increase efficient use of memory as programs are downloaded and executed.

### FIELD OF THE INVENTION

This invention relates to mobile devices and, more particularly, to a methods and apparatus for managing applications and data for a mobile device.

### BACKGROUND OF THE INVENTION

Mobile devices, such as mobile telephones, personal digital assistants (PDAs), have become increasingly sophisticated in ability to perform functions. As the effort to miniaturize mobile devices has progressed, designers of these devices have also been able to place increasingly powerful processing power in these devices because of advances in microelectronics. Concurrent with the increase in sophistication of these mobile devices, the systems in which mobile devices operate have been developed to offer higher data rates and more services. Various devices that combine the functions of mobile telephones and PDAs while operating in these systems are now being proposed and developed.

One problem with having smaller size mobile devices perform increasingly sophisticated functions is that memory storage capacity in main memory may be limited in a smaller device. PDAs for example have limited memory. This problem is often overcome by adding additional secondary external or internal memory such as MMC. Even then, however, data on external memory may not be compatible with the PDA memory as provided by the PDA supplier or as qucikly accessible as data stored on main memory. As PDAs are combined into mobile devices that are capable of performing multiple functions of increasing sophistication, memory limitations could become a factor in mobile device performance.

### SUMMARY OF THE INVENTION:

The invention presents a method and apparatus for managing applications and data for mobile devices. In the method and apparatus, external memories of the mobile device and/or network storage may be used as secondary storage locations for relatively low use programs and data loaded into the mobile device in a communications system. Both program and data may be stored in the secondary locations. According to the method and apparatus, the handling and management of storage in the external memory and/or network storage and, the handling and management of the programs and data in the device are performed in predetermined manner to increase efficient use of memory. If main memory or cache memory capacity is available in the mobile device, the method and apparatus may be utilized to store programs in the main memory or cache device, as long as no program exists in the mobile device having a higher priority for storage in the main memory or cache memory. This would allow quicker access to the program. If no main memory or cache memory were available for a program the program then would be stored in secondary or network storage, depending on preferences. For example, programs requiring small data storage areas that are not used frequently, such as a game, may be stored in network storage and retrieved on line when a user of the mobile device desires to use the program. The retrieved program may be stored in the memory of the mobile device with the memory of the mobile device serving as cache. Applications and data could be swapped in and out of the memory of the mobile device according to use. Programs that are generic or offered by a service provider may be cached locally in the main memory of the mobile device. Security and immunity from virus infection could be prevented by implementing download/swap-in mechanisms that validate the integrity of the program being loaded. Data files could be handled in a similar manner.

According to an embodiment of the invention, a launcher program is implemented into the mobile device. The launcher program is preconstructed or preconfigured to reference a defined network location for target executable programs. The launcher program has the capability to access the network location and secondary storage using necessary mechanisms and algorithms according to the relevant technology. The launcher program may support a variety of different methods and use those suitable to the available secondary storage media. When loaded and executed in the mobile device The launcher program first determines a users intent for use of a target program desired to be downloaded from the network location and stores information on this for future launches. After the target program is downloaded from network storage by the user, the launcher program determines and controls how the program is used. If a target program is to be stored in secondary storage, the user's desired location is requested via a prompt in order that the target program may be stored in one of any number of secondary storage locations, such as SIMM, MMC, PCMCCIA memory card, PCMCIA disk drive, or alternatives. If local storage is to be used, the target program is downloaded to local storage or main memory or cache memory and control is transferred to the target program. Various alternatives for storage may be followed depending on the current state of available memory and other programs that are stored in the mobile device. Additionally, the selected program may be loaded into the mobile device by other means than through network data transfer, if the mobile device is not network capable, such as cable or infrared.

The launcher program of the embodiment provides the functions of validation of the target program as it is loaded from network storage or a secondary storage location. The launcher program operates according to control parameters that may be definable by the user of the mobile device. When target programs are loaded into local storage or cache, the launcher program tracks parameters such as program size, the amount of time the program has been stored in the mobile device, priority of use, amount of use and last time of use of the target program. Based on these parameters, the launcher program manages the cache or local storage in the mobile device according to user predefined control. For example, the least used target programs or target programs that are stored longer than a predetermined period in local storage without use may be deleted from local storage. When the launcher program is invoked for a particular target program, the launcher program uses information retained from the tasks of managing the target program storage. On subsequent uses of a target program that was loaded from network storage, the launcher program would load from the location in which the program is stored and transfer control of the target program.

### BRIEF DESCRIPTION OF THE DRAWINGS

FIG. 1 is a block diagram of a mobile device according to an embodiment of the invention;

FIG. 2 is a flow chart illustrating process steps performed by a launcher program according to an embodiment of the invention.; and

FIG. 3 is a flow chart illustrating process steps performed in step 308 of FIG. 3.

### DETAILED DESCRIPTION OF THE INVENTION

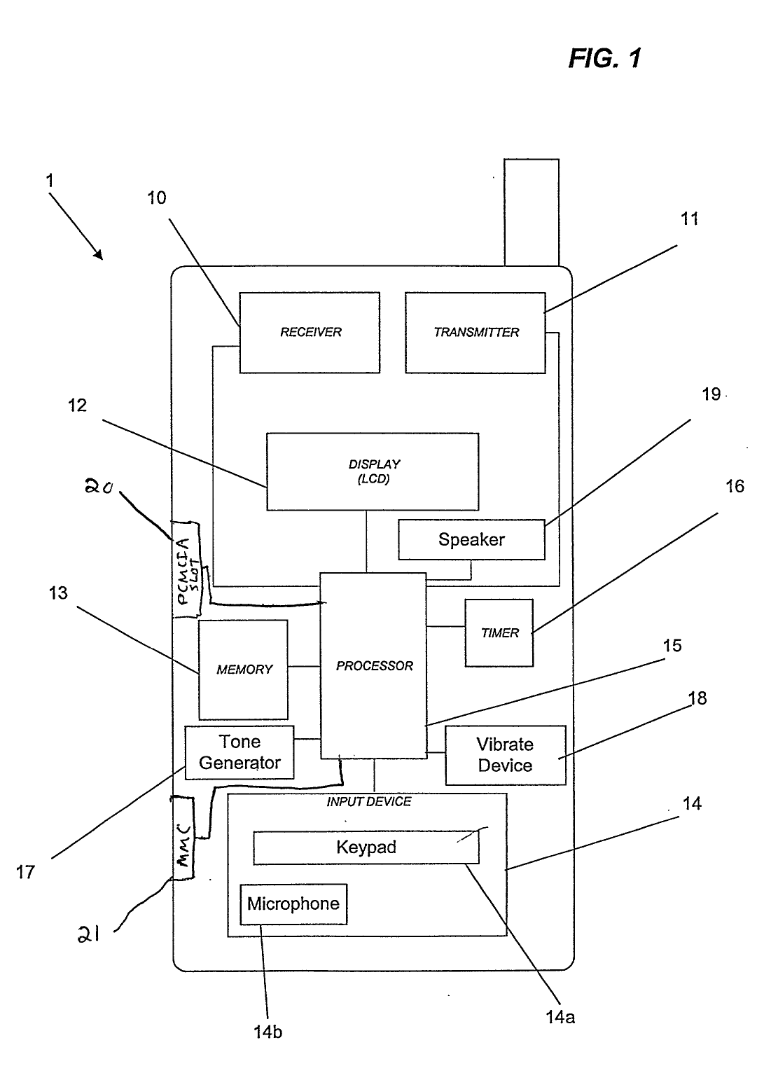

Referring now to FIG. 1, therein is a block diagram of a mobile device according to an embodiment of the invention. According to the embodiment, mobile device may be a media phone device. Alternatively, mobile device 1 may be any other type of mobile device, such as, for example, a personal digital assistant (PDA) or a mobile telephone that provides the function of running executable programs of sophisticated function, but that has limited local storage memory capacity for program storage. In the embodiment, mobile device operates in a wireless communications network that provides capability to transfer data and programs between the network and mobile device. The network may operate, for example, according to the global systems for mobile communications standard (GSM) using general packet radio services (GPRS) or the enhanced data rates for global evolution (EDGE) or, the IS-136 time division multiple access (TDMA) system standard, using the EDGE standard. Other systems include 3^{rd} generation wide band CDMA (WCDMA), CDMA2000 or IMT-2000 systems or, any other system providing data transfer capability.

Generally, mobile station 1 includes receiver 10, transmitter 11, and controller (which may also be known as a processor) 15 that is coupled to transmitter 11 and receiver 10. Processor 15 initiates the transmission of outgoing signals and processes incoming signals. These signals may include signalling information in accordance with the air interface of the applicable cellular or digital system, and also user-speech and/or user-generated data.

A user interface includes a Liquid Crystal Display (LCD) 12, tone generator 17, speaker 19, vibrate device 18 and user-input device 14 comprising keypad 14a, all of which are coupled to processor 15. The input device may also comprise microphone 14b for generating input. Mobile station 1 also comprises timer 16 (also referred to as a clock chip) coupled to processor 15 for synchronising the operations of processor 15 and tracking time.

Mobile station 1 also includes various memories, shown collectively as memory 13. Memory 13 includes a plurality of stored constants and variables that are used by processor 15 during the operation of mobile station 1. For example, memory 13 stores the values of the various feature parameters and the number assignment module (NAM). An operating program for controlling the operation of processor 15 is also stored in memory 13 (typically in a read-only memory). Memory 13 is also used to store data provided by the user through the user interface. Furthermore, memory 13 is used to hold the subprograms or subprocesses for controlling the operation of mobile station 1 and carrying out the embodiment of the invention. The operating program in memory 13 includes routines for that control processor 15 to perform functions according to the embodiment of the invention. Mobile station 1 also is capable of receiving secondary storage location capability at PCMCIA slot 20 and MMC slot 21. PCMCIA slot may be used to connect a PCMCIA memory card or PCMCIA disk drive to use as a secondary storage location.

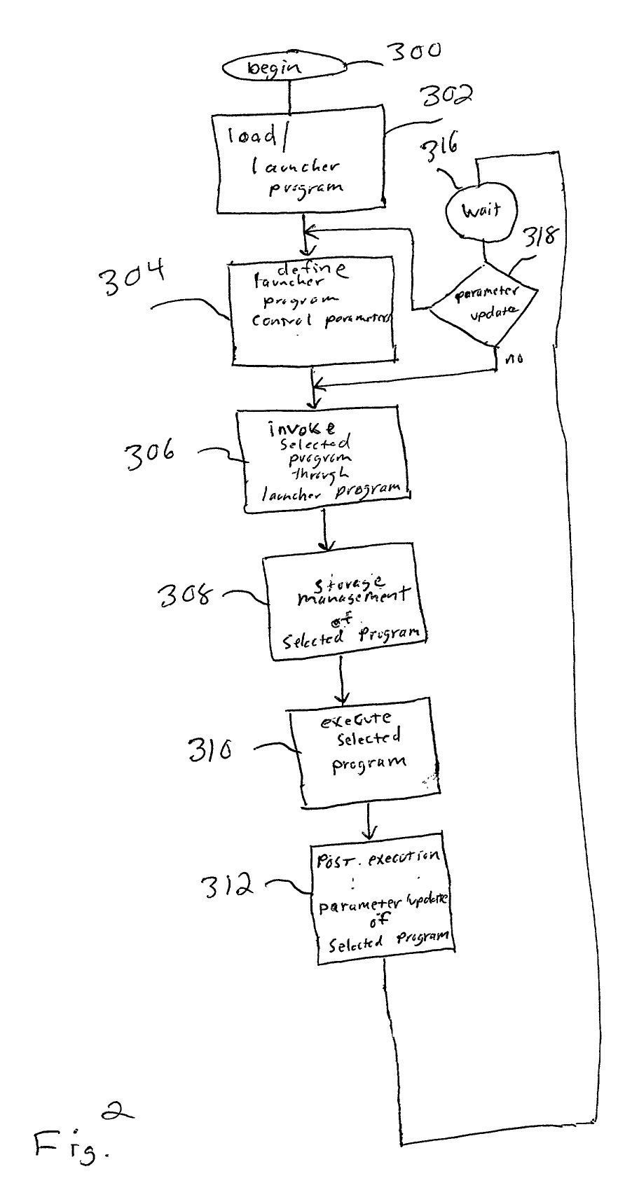

Referring now to FIG. 2, therein is a flow chart illustrating process steps performed when using a launcher program according to an embodiment of the invention. The process begins at 300. At step 302 the launcher program is loaded into mobile device 1. The program may be loaded over the communications channel air interface or by others means such as cable connection to a personal computer or service provider's programming station. The launcher program resides in the mobile device and may be implemented as configured by the service provider or implemented to be user configurable In the embodiment of FIG. 2, at step 304, the user is prompted to enter input for defining control parameters that control storage management and a storage configuration in the mobile device for one or more programs. The control parameters may be defined broadly or be program specific for programs included in a selection package provided by the network service provider. For example, all programs designated as “games class” may be given a low storage priority. The storage priority may define the relative priority of allowing a program to be stored on the mobile device when storage capacity is limited. Programs designated as “organizer class” may be given a priority higher than the storage priority given the “games” programs. Alternately, the storage priority of specific program having a low-storage priority for its class may be given a higher priority. The control parameters may define where a certain class of programs or a specific program is to be stored on the mobile device. For example, “games class” programs may be defined to be stored on PCMCIA memory only if space is available from higher priority programs or otherwise only on the network, while “organizer class” programs may be specified to be stored on PCMCIA memory with priority. Next, at step 306, a selected program is invoked through the launcher program. In the embodiment, the launcher may allow invocation of a selected program included in the selection package provided by the network service provider.

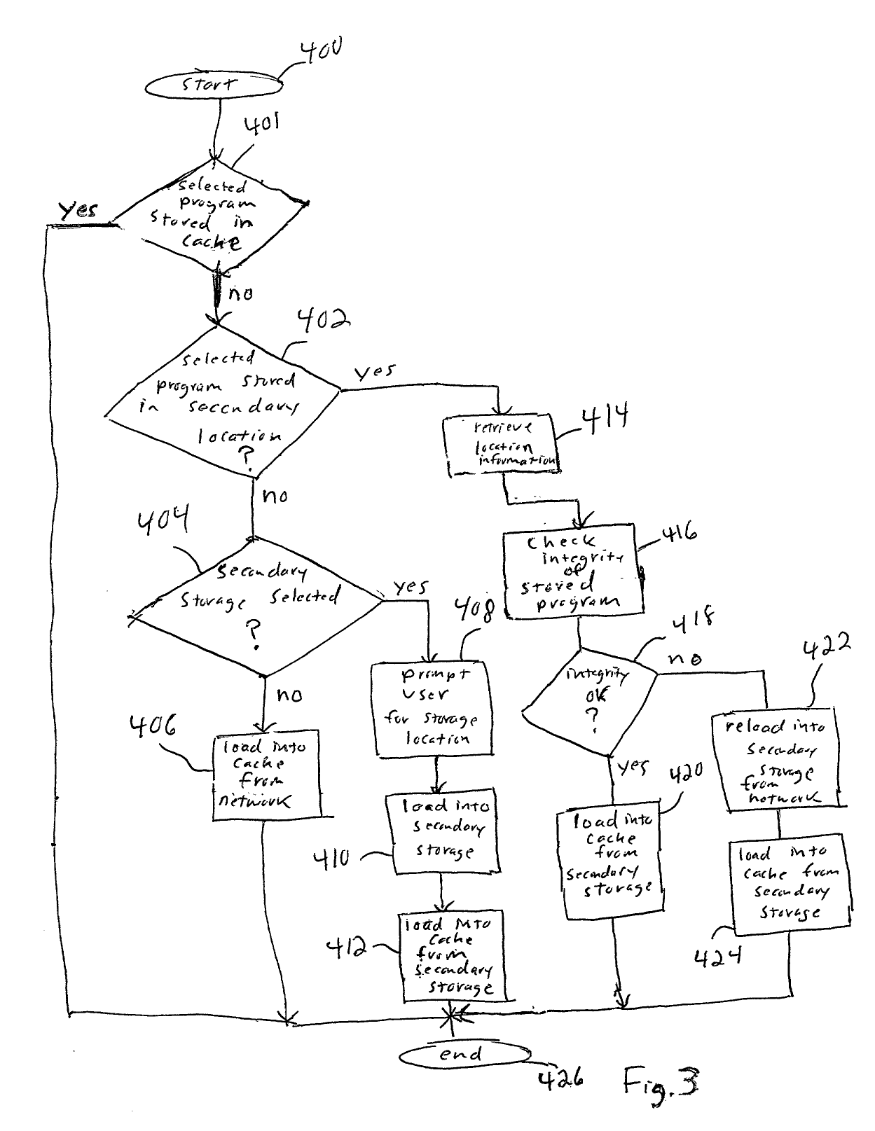

Next, at step 308, storage management of the selected program invoked at step 308 is performed. Referring now to FIG. 3, therein is a flow chart illustrating process steps performed in step 308 of FIG. 3. The storage management according to the embodiment of FIG. 3 is performed as illustrated in FIG. 3. The process begins at 400. At step 401 a determination is made as to whether the selected program is stored in the main memory of the mobile device from a previous use. If the selected program is stored in the main memory from a previous use, the process moves to step 310 and the program is executed. Alternatively to executing the selected program directly from main memory as in steps 401 and 310, the user may be given the option of, by prompt or otherwise, storing the selected program in secondary storage if the selected program is in main memory but not in secondary storage. If however, at step 401, it is determined that the selected program invoked in step 306 is not stored in main memory, the process moves to step 402. At step 402 a determination is made as to whether the selected program is stored in a secondary-storage location in the mobile device. If the selected program is not stored in secondary storage, the process moves to step 404. At step 404 a determination is made as to whether the launcher-program, control parameters indicate that the selected program is to be stored in secondary storage. If it is determined that the selected program is not to be stored in secondary storage, the process moves to step 406. At step 406 the selected program is loaded into main memory form the network. If however, at step 404, it is determined that the selected program is to be stored in secondary storage, the process move to step 408. At step 408 the launcher program prompts the user to enter a desired secondary-storage location. Alternatively, the control parameters entered at step 304 may be used to indicate the desired secondary-storage location for the selected program. Next, at step 410, the selected program is loaded into the secondary storage from the network and then into main memory at step 412. The selected program is then executed at step 310.

If however, at step 402, it is determined that the selected program is stored in secondary memory, the process moves to step 414. At step 414 location details on how and where the selected program is stored in secondary storage are retrieved. As an alternative, at step 414 the user could be given the option to modify the storage location through a series of steps similar to steps 408-412. Next, at step 416, the integrity of the selected program as stored in secondary storage is checked. This could be done using a series of checksums or equivalent mechanisms. If it is determined that the stored selected program has maintained integrity, the process moves through step 418 to step 420. At step 420 the selected program is loaded from the secondary storage to the main memory of the mobile device. If however, at step 418 it is determined that the stored, selected program has not maintained integrity, the process moves to step 422. At step 422 the selected program is loaded from the network to the secondary storage of the mobile device and the stored version of the selected program in secondary storage is replaced by the loaded version of the selected program. Next, the process moves to step 310 and the selected programs are executed.

At step 312 post-execution, control-parameter update and storage management is performed on the selected program. Control-parameter update may include updating parameters that the launcher program uses on subsequent invocations of the selected program. For example, parameters indicating that the selected program remains stored in secondary storage and/or main memory after execution may be updated. Parameters related to other programs that were effected by the invocation of the selected program may also be update. For example, if a lower priority program is replaced in both or one of the secondary storage or main memory of the mobile device during the process of FIG. 2 and FIG. 3, these parameters may be updated.

According to the embodiment, when the selected program is placed in main memory it will be a candidate for purging, but will not be purged unless a memory demand arises. A second program being launched may require the memory space used by the selected program. If the amount of main memory were adequate, a user could toggle between several programs in the mobile device without the programs being purged, allowing faster access to the programs.

The launcher of the embodiment could also be used to manage the storage of data files or records. In one embodiment of this, the launcher would require that a remote location, e.g., a user-network folder, where the files are placed when the need for the memory space taken up by them is required. If no network connection is available when the need for the memory space taken by the files arises, then the data will be placed on secondary storage. Sets of data could be retrieved independent of whether it is stored on main memory or secondary storage. For example, a playlist could be found using data-file-locating methods. When the application is invoked, the files comprising the playlist are retrieved from a personal web location or personal net folder, then the application could be launched to effect the result. In the embodiment, efficiency of launch is maintained by having the first item start to be utilized prior to a second time being fetched.

One skilled in the art will realize that the method and apparatus may be implemented in various types of systems or networks and various types of mobile devices. Thus, while the invention has been particularly shown and described with respect to preferred embodiments thereof, it will be understood by those skilled in the art that changes in form and scope may be made thereon without departing from the scope and spirit of the invention

What is claimed is:

1. A method for managing applications in a mobile device having storage capacity including a secondary storage location and a main memory, the mobile device operating in a communications network having a network storage location, the method comprising the steps of:
defining control parameters, said control parameters defining at least a storage configuration for applications including a selected program within the storage capacity of the mobile device, said application to be downloaded from the network storage location
receiving input for invoking said selected program in the mobile device, wherein said selected program is stored in the network storage location;
performing storage management of said selected program based on said control parameters as defined by said input data, said storage management including loading said selected program from the network into at least the mobile device; and
executing said selected program from the main memory of said mobile device.

2. The method of claim 1, wherein the step of defining comprises the step of receving input data at the mobile device, said input data defining said control parameters.

3. The method of claim 2, wherein the step of defining further comprises, before the step of receiving, loading a launcher program from the communications network into the mobile device.

4. The method of claim 1, wherein the step of performing storage management of said selected program comprises, before the step of loading said selected program from the network, the step of determining that said selected program is not stored in the main memory of the mobile device.

5. The method of claim 1, wherein the step of performing storage management of said selected program comprises, before the step of loading said selected program from the network, the step of determining that said selected program is not stored in the secondary storage location of the mobile device.

6. The method of claim 1, wherein the step of performing storage management of said selected program comprises determining that said control parameters indicate that said selected program is to be stored in the secondary storage location of the mobile device and the step of loading said selected program from the network comprises loading said selected program into the secondary storage location of the mobile device.

7. The method of claim 6, wherein the step of executing said selected program comprises the step of loading said selected program from the secondary storage location into the main memory of the mobile device.

8. The method of claim 1, wherein the step of performing storage management of said selected program comprises the step of determining that said selected program is stored in the secondary storage location of the mobile device and that said selected program has been corrupted in the secondary storage location of the mobile device and wherein the step of loading said selected program into the mobile device comprises reloading said selected program into the secondary storage location of the mobile device.

9. The method of claim 1, wherein the step of performing storage management of said selected program comprises, before the step of loading said selected program from the network, the steps of determining that said selected program is stored in the main memory of the mobile device and that said selected program has been corrupted in the main memory of the mobile device.

10. The method of claim 1, wherein said at least one control parameter comprises a storage priority for said selected program and wherein the method further comprises the steps of storing said selected program in the main memory of the mobile device until main memory capacity is needed.

11. A method for managing applications in a mobile device having storage capacity including a secondary storage location and a main memory, the method comprising the steps of:
defining control parameters, said control parameters defining at least a storage configuration for applications including a selected program within the storage capacity of the mobile device, said application to be loaded into the mobile device;
receiving input for invoking said selected program in the mobile device;
performing storage management of said selected program based on said control parameters as defined by said input data, said storage management including loading said selected program into the mobile device; and
executing said selected program from the main memory of said mobile device.

12. The method of claim 11, wherein the step of defining comprises the step of receving input data at the mobile device, said input data defining said control parameters.

13. The method of claim 12, wherein the step of defining further comprises, before the step of receiving, loading a launcher program into the mobile device.

14. An apparatus for managing applications in a mobile device having storage capacity including a secondary storage location and a main memory the apparatus comprising:
an input device for defining control parameters, said control parameters defining at least a storage configuration for applications including a selected program within the storage capacity of the mobile device, said application to be loaded into the mobile device; said input device further for receiving input for invoking said selected program in the mobile device; and,
a processor coupled to said input device, said processor for performing storage management of said selected program based on said control parameters as defined by said input data, said storage management including loading said selected program into the mobile device, and executing said selected program from the main memory of said mobile device.

15. The apparatus of claim 14, wherein said input device further receives input data at the mobile device, said input data defining said control parameters.

16. The apparatus of claim 15, wherein the processor further loads a launcher program into the mobile device before loading said selected program.
